(19) United States
(12) Patent Application Publication
(10) Pub. No.: US 2012/0310774 A1
(43) Pub. Date: Dec. 6, 2012

(54) ELECTRONIC PAYMENT SYSTEM

(76) Inventor: Christophe CHASSIN, Matha (FR)

(21) Appl. No.: 13/149,023

(22) Filed: May 31, 2011

(51) Int. Cl. G06Q 30/00; G06Q 40/00

(52) U.S. Cl. 705/26.41; 705/42

(57) ABSTRACT

An interbank online payment system connecting consumers, consumer banks, merchants and merchant banks via a fixed and/or a mobile telecommunication network, wherein said payment system comprises an automated information system adapted to communicate with a plurality of national banks affiliated to said payment system, a plurality of fixed payment terminals, and a plurality of mobile payment terminals. Said automated information system comprises an aggregation module that manages a plurality of personal user accounts, said automated information system giving said consumers access to a plurality of services including payment, cash withdrawal and/or money transfer.

### TECHNICAL FIELD OF THE INVENTION

The present invention pertains to the field of electronic payment. More particularly, it relates to an online payment system, as well as an international electronic payment system.

### BACKGROUND ART

Nowadays, a number of means of payment are available to the public: cash payment, checks, bank cards, transfer payment, as well as most recent payment solutions, which are generally intended for payment on the Internet and/or through a mobile terminal.

Cash payment and payment by means of checks are currently declining, while the success of bank card payment is growing and the above-mentioned recent payment solutions are being developed.

Each of these known means of payment has a number of drawbacks. In particular, cash payment does not make it possible to purchase online. Check payment is generally not accepted for online purchase either and represents risk of non-payment for merchants.

Payment by means of a credit card is not always secured, because the consumer has to communicate personal credit card details to the storekeeper or has to enter a PIN code in presence of other people and, in the case of online purchase, has to input on the internet credit card confidential information, which may be intercepted and used fraudulently by a third party.

Moreover, the functionalities of credit cards are rather limited i.e. they relate basically to payment and cash withdrawal operation, which means that they offer a very restricted number of services to the card owner. For instance, usually, a credit card does not make it possible for the card owner to store personal data, to read e-mails and to surf on the Internet.

In addition, a credit/debit card does not allow the card owner to consult the balance of his account while completing payment, cash withdrawal or money transfer operations. Moreover, if the card owner has two or more credit/debit cards, he cannot check the balance of each account while completing a payment, cash withdrawal or money transfer operation in order to select the most appropriate account for this operation.

The lack of security of online payment via bank card has recently promoted the development of a number of Internet and mobile payment solutions.

Among recent internet payment solutions, Paypal (registered trademark) enables any Internet user having an email address and a bank card to transfer money and complete an online purchase without giving any personal credit card details to the cybermerchant. This is because the user has first created a Paypal account, by entering once and for all details of the credit card to be debited when purchasing online.

Although this increases the security of online payments, this type of solution has drawbacks. One drawback is that the user needs to create and fund a separate (Paypal) account from his bank accounts. Another drawback is that the Paypal service does not provide the user with services other than a payment service (it is not a “rich” payment service). Moreover, it does not enable the user to make “smart” spending decisions as the user cannot control the balance of his different bank accounts before performing a transaction and select the preferred account for the concerned transaction. Furthermore, Paypal is currently intended for virtual shopping only, i.e. completing a purchase in a physical shop is not presently possible with this type of payment solution.

### SUMMARY OF THE INVENTION

The present invention aims at remedying at least partly the above-mentioned drawbacks.

According to one aspect, the invention provides an online payment system connecting at least consumers, consumer banks, merchants and/or merchant banks via a fixed and/or a mobile telecommunication network. The payment system comprises an automated information system adapted to communicate with a plurality of national banks affiliated to said payment system, a plurality of fixed payment terminals, and a plurality of mobile payment terminals. Said automated information system comprises an aggregation module that manages a plurality of personal user accounts, said automated information system giving said consumers access to a plurality of services including payment, cash withdrawal and/or money transfer.

The term “bank” designates any institution providing financial services, and being under prudential supervision and regulation.

The term “payment terminal” designates any terminal or device adapted for performing a financial transaction, such as a payment, cash withdrawal or money transfer operation.

The automated information system may typically be a server linked to the internet. The aggregation module may be installed on the automated information system or on client systems (i.e. payment terminals). The aggregation module comprises instructions (source code of a computer program) recorded on a data storage medium (any hardware memory, e.g. a hard disk, a flash memory, CD, DVD, etc.). These instructions are for aggregating user accounts. Aggregating user accounts may include accessing to other servers hosting such accounts and importing at least some data related to such accounts. Notably, the aggregation module may comprise functions for accessing at least two bank accounts of a user, each of the two bank accounts being hosted by a different bank. Such aggregation module may further comprise functions for importing a balance of such accounts (e.g. an amount on the account). Thus, in such a case, the aggregation module gathers at least bank account balances of user bank accounts at two different banks. In case the automated information system further comprises an interface module which comprises instructions recorded on a data storage medium, the system may provide for displaying the balance of the user bank accounts at, at least, two different banks. The aggregation module thus offers a high level of information to the user, who may perform a payment with more ease. Notably, if the balance of two different of his bank accounts (at different banks) is displayed to a user in the course of performing an online or an electronic payment, the user may make a smarter decision as to which account to debit.

The system may optionally be a national interbank (i.e. four-party) online payment system, i.e. a system gathering banks operating in the same country. On such national territory, online payment is made a lot easier for the users. According to another aspect, the invention also provides an international online payment system comprising a network of at least two national interbank online payment systems according to the above.

According to another aspect, the invention provides an internet payment system which may be a server or a client (e.g. comprising a communication device for connecting a communication network). The system comprises an aggregation module, the aggregation module comprising a data storage medium having recorded thereon a computer program including instructions to aggregate a plurality of personal user accounts, including at least two bank accounts of different banks (possibly as described above). The system also comprises an interfacing module, the interfacing module offering users an access to a personal graphical user interface and comprising a data storage medium having recorded thereon a computer program including instructions to display on a single view data related to the plurality of personal user accounts, including balance data of the two bank accounts (i.e. so that these information are displayed simultaneously to the user). The system also comprises a payment module, the payment module comprising a data storage medium having recorded thereon a computer program including instructions to perform electronic or online payment through user-interaction with the personal graphical user interface.

The system allows the simultaneous display e.g. on a screen of a payment terminal (such as a computer or a mobile phone, or a PDA, or any other electronic communication device), of a balance of two different bank accounts (at different banks) of a user. Taking advantage of such display, the user may then act on the graphical user interface to perform the payment. The user-interaction may be as simple as selecting one of the accounts, i.e. the account to be debited, e.g. by clicking on an appropriate icon, and then clicking on a “payment” button of the graphical user-interface. Of course, safety measures or advertising events may occur within the payment course, as will be described in further details referring to the preferred embodiments.

According to another aspect, the invention provides a method for performing an online or an electronic payment. In this case, the user is purchasing a product online or electronically in a store. The method comprises importing information related to a product in a graphical user interface of a fixed or a mobile payment terminal. For example, the graphical user interface is as described above. Importing means that data related to the product (e.g. its price, its seller merchant) may be embedded in the interface when opening the payment service account of the user. Typically, the user may access a web page containing information related to the product (such as the basket page or the payment page) on a merchant Website, and click on a dedicated icon on that page (the dedicated icon redirecting the user to his payment service). Or, the user may read the code bar on a physical product, e.g. in a physical shop, with an electronic device capable of such reading, and access directly to the payment service thereafter. Within the payment service interface, the user may observe the balance of his different bank accounts and purchase the product accordingly (the relevant data having been imported). Thus, the payment method comprises displaying to the user, on a display (e.g. a screen) of the payment terminal, balances of at least two bank accounts of different banks. The method also comprises selection by the user of one of the two bank accounts, e.g. based on the displayed balances, thereby launching purchase of the product by payment from the selected bank account. The eventual finalization of the purchase may be subject to ulterior user actions or verifications.

In embodiments, the system may work with an internet service which has the advantage of:
being easy to use,
offering high security of payment both for the purchaser and for the merchant,
being parameterizable and customizable,
being linkable to a checking, credit or prepaid bank account,
making it possible to promptly complete any purchase whether online or in a real shop,
being a full internet portal giving access to a multiplicity of services other than payment,
helping users to make smarter spending decisions by allowing them to consult their bank account balance before completing a payment, cash withdrawal or money transfer operation,
be linkable (or aggregatable) to one or more other internet services so that consumers can use all these internet services at the same time to complete a payment, cash withdrawal or money transfer operation with the benefit of being able to consult the balance of each bank account associated with these services before completing a payment, cash withdrawal or money transfer and select the most adequate account for the considered transaction,
being usable throughout the entire world if the national interbank payment system is connected to one or more other national interbank payment systems through an international payment system (this international payment system being part of the invention).

### BRIEF DESCRIPTION OF THE DRAWINGS

Other characteristics and advantages of the invention will become apparent on reading the following description of particular embodiments of the invention given by way of non-limiting examples and with references to the accompanying drawings, wherein:

FIGS. 1A and 1B show examples of payment systems,

FIGS. 2A and 2B show examples of user interfaces, and

FIGS. 3A, 3B and 4 show examples of procedures related to online payment.

### DETAILED DESCRIPTION OF PREFERRED EMBODIMENTS OF THE INVENTION

The invention relates notably to an interbank electronic payment system, which may be a national interbank electronic payment system, hereafter referred to as a national interbank PS system (PS for “Payment System”), working with an Internet service, hereafter referred to as the PS service.

The PS service allows electronic payment of purchases of goods and services, cash withdrawal and any kind of money transfer on a territory, e.g. a national territory, either online, whether on the fixed Internet or on the mobile Internet. The PS service may also allow payment of purchases in a physical shop or in any other non-virtual location, via a mobile terminal using a contactless technology.

In addition to the above-mentioned electronic payment services, the PS service may be a private portal which enables users to access all their personal accounts on the Internet (email, bank accounts, etc.) and to access multiple services and contents.

National Interbank PS System

A national interbank PS system according to the invention may operate in a totally autonomous manner, independently of any other national interbank PS system, in which case the PS service can only be used in the country where the national interbank PS system is located.

A national interbank PS system may also be connected to one or more other national interbank PS systems, thanks to an international electronic payment system adapted to create, develop and manage a network of two or more national interbank PS systems (such an international payment system is hereafter referred to as an international PS system), in which case the PS service can be used in all countries where a national interbank PS system has been implemented. The invention also relates to such an international PS system.

A national interbank PS system is totally independent of the existing national and/or international bank card networks (and from any other type of card network). It relies on techniques used in the field of the World Wide Web, computer and telecommunications networks. Once again, these techniques are totally different from the techniques used by the known bank card networks.

In addition to the functions of emission, acquisition and clearing and settlement, a national interbank PS system may also perform a function of broadcasting advertisements on various media of the national PS system, namely, in the PS service (i.e. the payment and withdrawal service provided by the PS system) and in the back office of the PS affiliated merchants.

A national interbank PS system may link, through fixed and mobile networks (such as the Internet and telecommunications networks), users (i.e. consumers), banks, merchants and announcers (i.e. advertisers).

An example national interbank PS system is adapted to communicate with PS affiliated banks via an automated information system that is able to receive data from the banks and return data to the banks. The data received by the automated information system from the affiliated banks relate in particular to the balance of user bank accounts. The data sent by automated information system to the affiliated banks relate in particular to the amount of transactions performed by bank account users through the national interbank PS system when shopping online or in physical shops, when withdrawing cash and when transferring money.

In addition to the automated information system adapted to communicate with a plurality of national banks affiliated to the PS system, the PS system may comprise a plurality of fixed payment terminals adapted to accept payments made by means of the PS system in physical location such as real shops.

The PS system may further comprise a plurality of mobile terminals adapted to perform payments in real shops as well as on the mobile Internet, by means of the PS system.

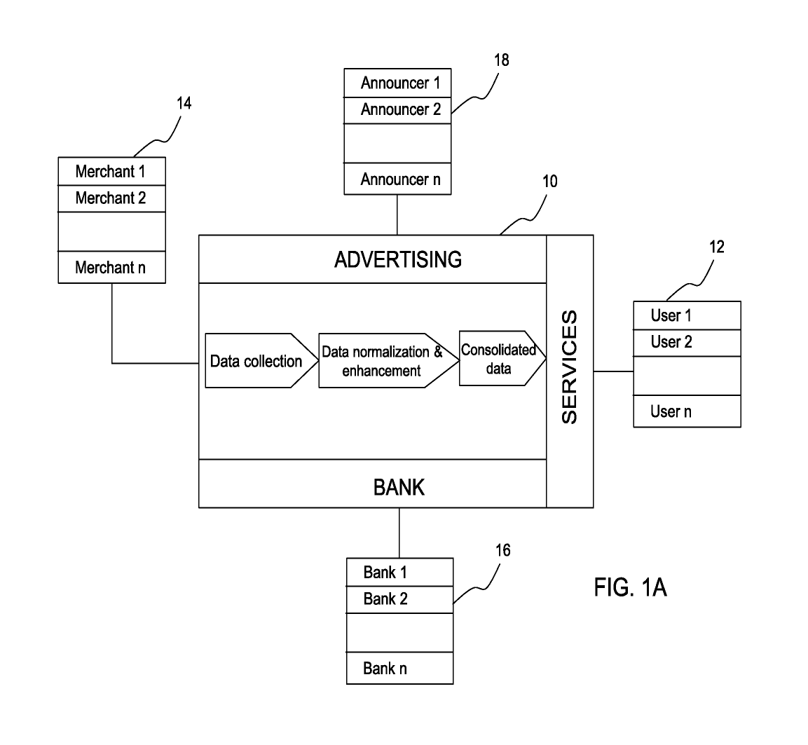

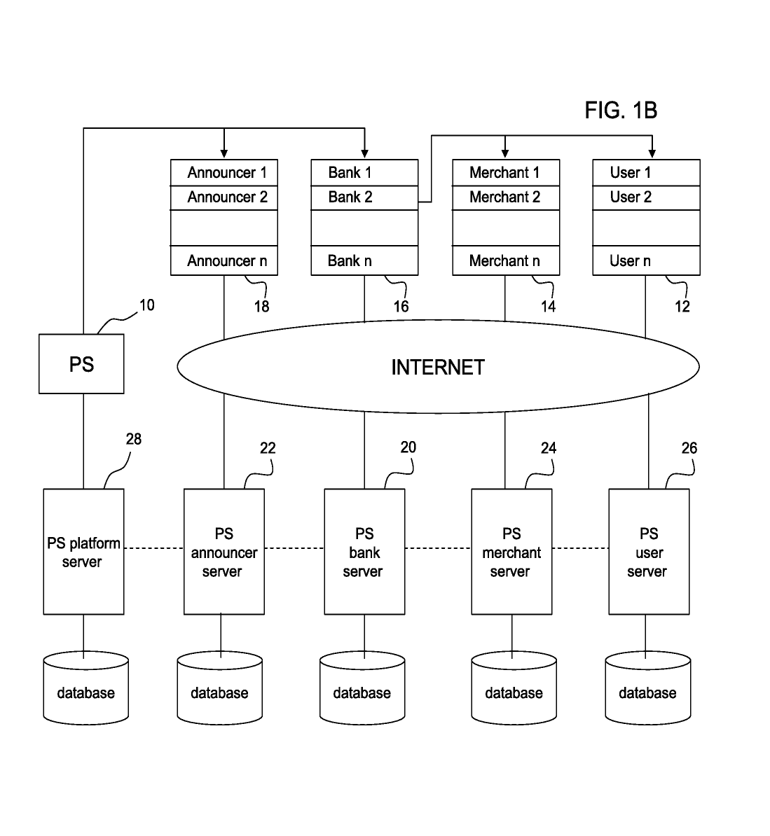

As shown in FIG. 1A, a national PS comprises a central platform 10, as well as on-demand applications by means of which users, i.e consumers, 12, merchants 14, banks 16 and announcers i.e. advertisers 18 communicate and exchange data with the central platform.

PS Central Platform

The central platform 10, hereafter referred as the PS central platform, is a conventional aggregation platform on top of which three modules (i.e. building blocks) are built: Bank (hereafter referred to as the “bank module”), advertising (hereafter referred to as the “advertising module”) and services (hereafter referred to as the “services module”). It is adapted to aggregate various items of information corresponding to one and the same user and coming from different sources of information, for example data from Internet accounts of the user (bank, email, etc. . . . ), personal data of the user (name, addresses, photos, etc. . . . ) and any other data relating to the user (loyalty cards of the user, etc. . . . )

The account aggregation technology is well known for the skilled person: information from different accounts (which may include bank accounts, credit card accounts, investments accounts, email accounts, etc. . . . ) are compiled and served into one single place so that internet users can access and view all their personal accounts on Internet at a glance, via a single identification procedure.

The PS central platform may work with any available aggregation technology, whether the account aggregation is done server-side or client-side. For example, the aggregation may be a “server-side” aggregation or a “client-side” aggregation, depending on whether the aggregation module lies on a server or on a payment terminal (i.e. client). With an aggregation module, the user may access to a personal PS account (e.g. by accessing to the PS service and then entering user identifier and user password), then request the aggregation of a new account (e.g. a new bank account from a new bank). The PS central platform may then perform the aggregation, possibly by requiring user-input of the identifier(s) and password(s) for accessing the account to be aggregated.

One of the main features of an account aggregation service is the possibility for the user to update his aggregated accounts (as the data of these aggregated accounts are not synchronized with those of the original accounts) through a manual (or automatic) “refresh” procedure. This “refresh” functionality makes it possible to deliver proper authorizations for payment and/or cash withdrawal and/or money transfer within the context of the PS system. The “refresh” procedure may also update the balance of the bank accounts which are aggregated.

The bank module makes it possible for the manager of the national interbank PS system, in particular:
to affiliate bank to the national interbank system, i.e. to create an account corresponding to the bank that will allow the bank to use the national interbank PS system;
to manage a basic range of PS services (such as immediate debiting PS service, delayed debiting PS service, credit PS service, prepaid PS service) from which the affiliated banks will create their own range of PS services.

The advertising module makes it possible for announcers to register in order to be able to broadcast advertisements on various media of the national interbank system, namely, in the PS services and in the back offices of the PS affiliated merchants.

The services module makes it possible for the manager of the national interbank PS system to manage and integrate (through new menus and/or new categories into a menu) the range of services and contents that are proposed by all PS services emitted from the national interbank system.

PS Applications

Four applications referred to as “PS bank”, “PS announcer”, “PS merchant” and “PS user” enable respectively the banks, the announcers, the merchants and the users/consumers to make use of the national interbank PS system according to their respective needs, via respective servers 20 (banks), 22 (announcers), 24 (merchants) and 26 (users/consumers) shown in FIG. 1B. The central platform 10 also has its server 28. All the servers use their own database and are adapted to communicate within each other (this is represented by dashed lines between the servers in the drawing).

With the “PS bank” application, the banks that are affiliated members of the national interbank PS system manage their PS payment activities (management of their PS service range, of their user accounts, of their merchant accounts, access to key data of their PS services). The “PS bank” application is available as a service which can be used and accessed anywhere using a simple Internet connection. The “PS bank” application is a multi-user and multi-profile application: banks have the possibility of managing a whole set of profiles (commercial attaches, agency managers, marketing managers, etc. . . . ) in an administration module, by giving them different access rights.

With the “PS Announcer” application, announcers can create, manage and follow their advertising campaigns intended for PS service users and/or for PS affiliated merchants. Similarly the “PS bank” application, the “PS announcer” application is available as a service which can be used and accessed anywhere using a simple Internet connection. The “PS announcer” application is a multi-user and multi-profile application: announcers have the possibility of managing a whole set of profiles in the administration module, by giving them different access rights.

With the “PS merchant” application, the PS affiliated merchants can access a detailed report of their transactions, in which the national interbank PS system gives for each transaction the full particulars of the purchaser. Customer Relationship Management (CRM) tools make it possible to use the collected data to launch different marketing campaigns. The “PS merchant” application is available as a service which can be used and accessed anywhere using a simple internet connection. Access to the application is provided by the purchasing (or acquiring) banks. The “PS merchant” application is a multi-user and multi-profile application: merchants have the possibility of managing a whole set of profiles in an administration module, by giving them different access rights.

The “PS user” application corresponds to the PS service. The application is available as a service which can be used and accessed anywhere using a simple internet connection. Access to the “PS user” application is provided by the emitting banks. By contrast with standard aggregation services, users cannot access freely to the PS service.

The PS Service

A New Means of Payment

The PS service is a new means of payment available on fixed networks as well as on mobile networks.

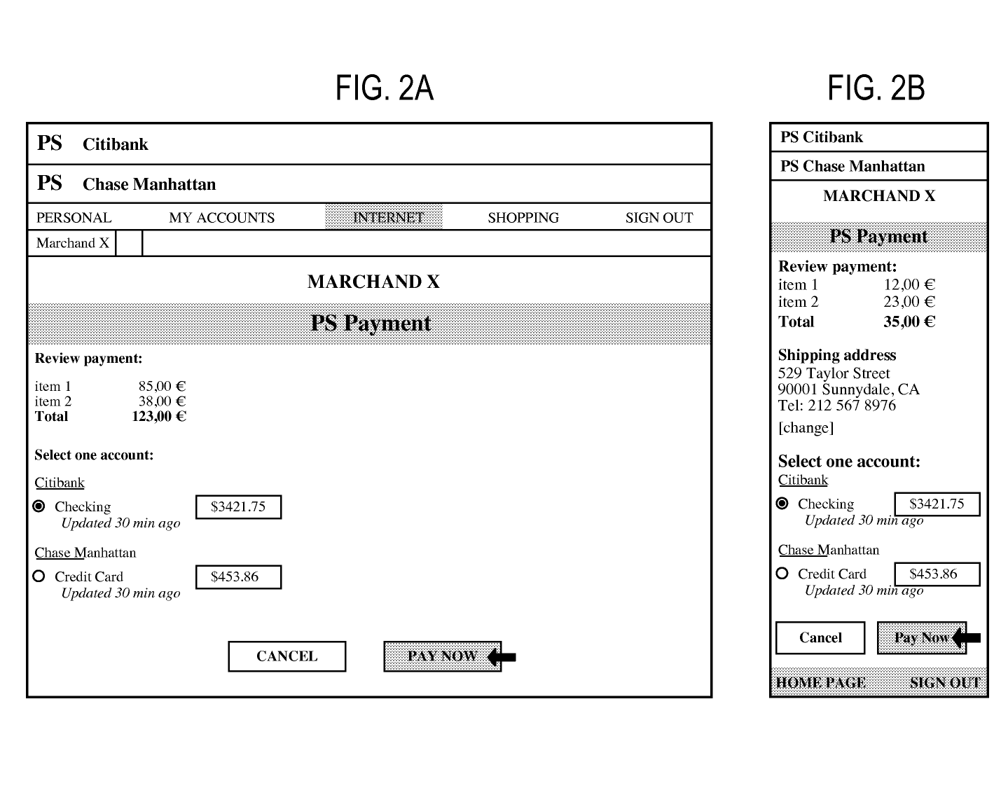

The PS service available on fixed networks is called the “PS Web service”. As shown in FIG. 2A, it can be accessed through a user interface comprising a customizable visual presentation and a menu bar allowing access to multiple services and contents and to sign out (i.e. disconnect). The PS web service allows electronic payment of goods and services on the fixed Internet.

The PS service available on mobile network is called the “PS mobile service”. As shown in FIG. 2B, it can be accessed through a user interface comprising a visual presentation similar to that of the PS Web service and a general menu of services and contents. The PS mobile service allows:
electronic payment of goods and services on the mobile Internet;
electronic payment of goods and services in physical shops and in any non-virtual location;
cash withdrawal.

Like a bank card, the PS service is connected directly to a bank account. This bank account may be a checking account (to pay “now”), a revolving credit account (to pay “later”) or a prepaid account (to pay “before”). Besides, the PS service offers at least as many operating options as a bank card (simple payment or cash withdrawal, national or international use, spending limits, etc. . . . ). Banks can thus create with this new means of payment and withdrawal a range of payment products similar to that they propose with the (plastic) card.

A Private Portal

In addition to be a means of payment, the PS service is an Internet portal giving access to a full range of services and contents.

In the case of the PS Web service, this range of services and contents may initially include:
services that enable users/customers to store and manage personal data (addresses, contacts, photos, etc. . . . ). Those services can be accessed through a menu called, for instance, “PERSONAL”;
an aggregation service, i.e. a service that enables users/customers to aggregate all their internet accounts on their PS Web service. The aggregation service can be accessed through a menu called, for instance, “MY ACCOUNTS”;
It is important to note that users/consumers can aggregate two types of accounts:
   transactional accounts, i.e. accounts to be used during operations of payment, cash withdrawal or money transfer. Transactional accounts are aggregated using specific identifiers and password transmitted to the users by their respective banks, following the signing of a contract of use with the PS service.
   non-transactional accounts, i.e. accounts not to be used during operations of payment, cash withdrawal or money transfer. Non-transactional accounts are aggregated in a conventional manner, using the usual identifiers and passwords of the users.
a navigating system that allows users/consumers to surf on the Internet in the closed environment of the PS Web service. This navigating system, which makes it possible to open or close simultaneously several Web pages, can be accessed through a menu called, for instance, “INTERNET”.
a virtual mall gathering all the cybermerchants affiliated to the national interbank PS system and domiciled in the country of emission of the PS Web service. The virtual mall offers the usual functionalities of a virtual mall, such as price search and comparison. Optionally, users can access the virtual mall of all the other countries of emission of the PS Service from the virtual mall of their PS Web service, so they can shop online in the whole world.

This is not a comprehensive list. The range of products/contents of the PS Web service may eventually include, through new menus or new categories of service in a menu, all services and contents that need user registration and/or payment.

In the case of the PS Mobile service, this range of services and contents may initially include:
access to the aggregated accounts of the users/consumers. Aggregated accounts can be accessed through a menu called, for instance, “MY ACCOUNTS”
a search engine for finding out which local mobile merchants sites accept PS payments. this search engine can be accessed through a menu called, for instance, “SHOPPING”.
a payment service that makes it possible for users/consumers to initiate a local payment in a physical shop. this payment service can be accessed through a menu called, for instance, “M-PAYMENT”
a withdrawal service that makes it possible for users/consumers to initiate a withdrawal operation at an ATM. This withdrawal service can be accessed through a menu called, for instance, “M-CASH”.

This is not a comprehensive list. The range of products/contents of the PS mobile service may eventually include, through new menus or new categories of service in a menu, all services and contents that need user registration and/or payment.

Requests for Payment Authorizations

Requests for payments authorizations, cash withdrawal authorizations or money transfer authorizations are generated automatically by the PS service according to its parameterization. Using the “refresh” function of its aggregation service, the PS service extracts the data from the bank account selected by the user for the transaction and obtains in real time the updated balance of that bank account. The PS service then compares the balance with the amount of the transaction. If the account is in sufficient credit to honor the transaction, the PS service delivers the requested authorization. Otherwise, the PS service refuses the transaction.

Optionally, the PS service is adapted to automatically trigger a request for authorization according to multiple criteria, such as the type of transaction and the period of time lapsed since the last update of the account

Also optionally, in order to shorten the waiting time before the response to the request for authorization is delivered, the account updating functionality (the so-called “refresh” function) of the aggregation service of the PS service is automatically activated when the user connects to the PS service. Thus, the waiting time will be very short or even zero when the request for authorization is made.

Activation of the PS Service by Consumers

In order to become a user of a PS service, the consumer has to sign a contract with a bank. The contract defines the relationship between both parties and the provisions of accessing and using the PS service.

Following the opening of a user account by the bank, the consumer automatically receives (by email, preferably encrypted, or any other secure means) the identifier and the password which will enable him to access his PS service. Two cases may then arise:
if the consumer is not yet a user of a PS service, he must subscribe as a new user. The subscribing procedure is two-fold: as a first step, the Internet user/consumer must pre-aggregate the bank account to which the PS service will be associated, by entering the identifier and password received from the bank. As a second step, he must himself choose an identifier and password which will enable him to access his PS service.
if the consumer is already a user of another PS service, he may proceed in two different ways to subscribe to a PS service: either to subscribe as a new user, in which case the PS services will be distinct and usable independently from each other; or to aggregate the account to which the new PS service will be associated from his other PS service, in which case the two PS services will be linked (or aggregated) and usable simultaneously in order to perform PS transactions.

At the level of the user interface, the aggregation of a transactional account from an existing PS service may trigger the displaying of the visual presentation of the PS service associated to that account. In this configuration, the two PS services are linked (or aggregated).

Access to linked (or aggregated) PS services may take place after one single user identification procedure, using the identifier and password initially chosen by the user for accessing the first PS service.

It is important to note that the consumer can link (or aggregate) as many PS services as he wants, whatever the emitting banks.

Acceptance of the PS Service by Merchants

In order to accept payments through a PS service on their Web and/or mobile Internet site, the merchants may have to sign a PS mail order contract with a bank. In order to accept payments through a PS service in one or more of their physical points of sale, the merchants may have to sign a PS convenience stores selling contract with a bank.

In a particular embodiment, following the opening of his account by the bank, the merchant automatically receives, in an email, which is preferably encrypted, or in a postal mail the identifier and password that may enable him to access his back office.

If the merchant has signed a mail order contract with his bank, he may also receive a guide for integrating the PS payment solution on his internet/mobile site (by simply adding to the Internet/mobile site a few HTML code lines or using APIs).

In order to accept payment through a PS service in his physical store(s), the merchant may have to use an adapted payment terminal, [i.e. with contactless capabilities and a PS merchant acceptance software].

Procedure for a PS Payment on the Fixed Internet

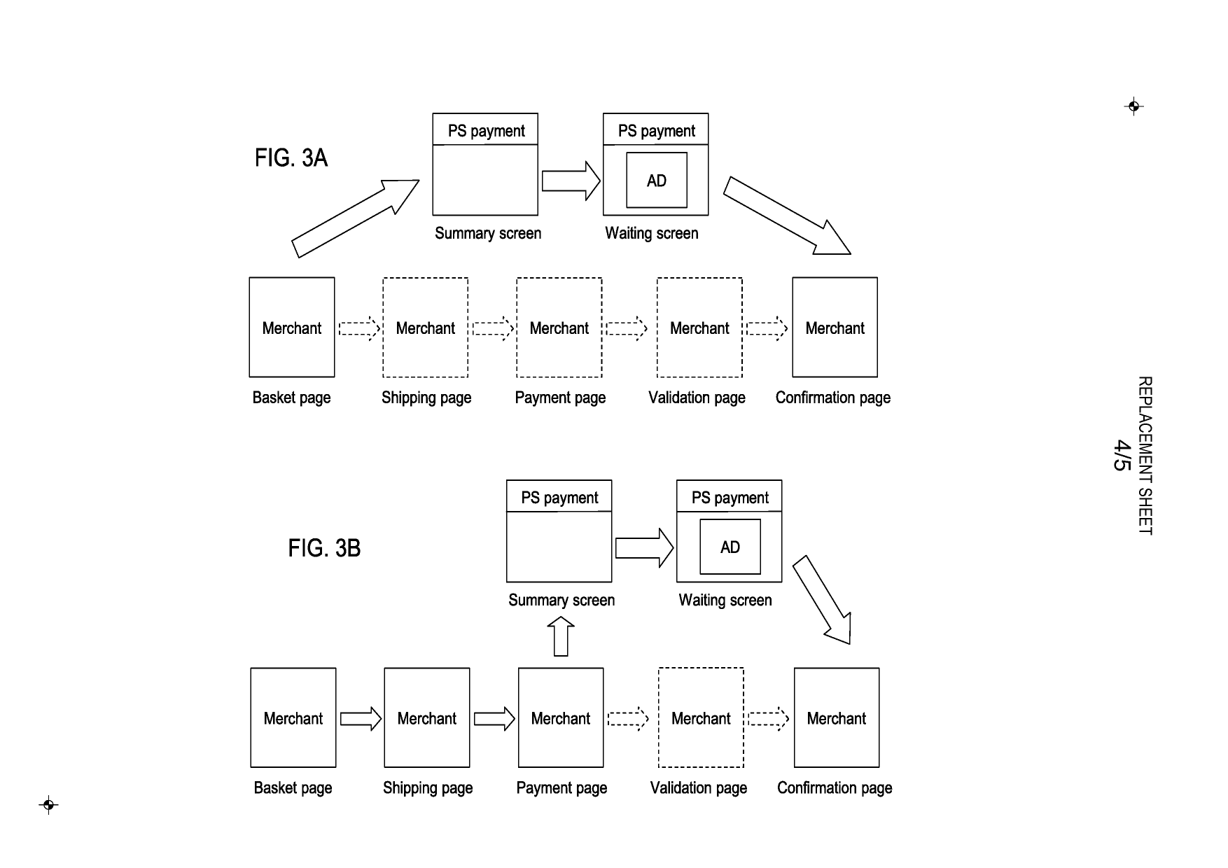

An online payment procedure using a system is described below in two different embodiments, with reference to FIGS. 3A and 3B.

In a first embodiment shown in FIG. 3A, a user can initiate a PS payment from the “basket” page of a merchant Internet site.

In the particular embodiment of FIG. 3A, the user initiates the PS payment by selecting, e.g. by clicking on a button, “PS Payment” displayed on the basket page (i.e. the screen summarizing the purchase, contained in a virtual purchase basket) of the merchant site.

If the internet user initiates the payment without being registered as a user of the PS service, he is first invited to subscribe to that service. He will then access directly the basket page of the merchant site within the private environment of his PS service, and not the home page of this PS service.

The user then accesses a PS interface (“Summary screen” in FIG. 3A) from which he can:
view the brief summary of his order,
confirm or modify the address for the delivery of his order,
select the transactional account with which he wishes to pay his purchase (in case the user uses two or more linked PS services)

Thus, the user may be able to check the balance of the transactional account(s) before paying his purchase, without having to separately connect to the Internet sites of his banks, and to select that transactional account which is the most appropriate to pay the purchase. This makes it possible for the user to better control his expenses.

Preferably, the PS interface displays only the transactional accounts linked to PS services that make it possible to perform the transaction. For example, if the user wishes to make a purchase abroad (i.e. from a merchant located outside the country where the user lives), preferably only the transactional accounts enabling payments abroad will be displayed. If none of the transactional accounts of the user allows the transaction, the payment will be interrupted and the user will not be allowed to select an account.

After selection of a transactional account by the user, if the transaction is not subject to an authorization request, the user carries out the last step of the payment procedure, which is described below.

On the other hand, if the transaction is subject to an authorization request, an intermediary screen (“Waiting screen”) in FIG. 3A is displayed, inviting the user to wait for the response to the authorization request.

The waiting screen may be displayed during a few seconds, even if the updating of the selected transactional account is terminated. This is because the waiting screen displays a targeted advertisement (“AD” in FIG. 3A).

If the response to the authorization request is positive, the user carries out the last step of the payment procedure, described below.

On the other hand, if the response to the authorization request is negative, a second intermediary screen (not shown in FIG. 3A) is displayed, which informs the user of the refusal of the payment authorization and which invites the user to select another transactional account.

Following acceptance of payment, the user carries out the last step of the payment procedure, which consists of accessing the page of confirmation of his order on the merchant site (within the navigation frame of his PS service).

The page confirms the transmission of payment and of the billing and delivery address to the merchant.

As shown by the dashed lines in FIG. 3A, the usual shipping page, payment page and validation page of the merchant site are replaced by the summary screen and the waiting screen of the PS system.

In a second embodiment shown in FIG. 3B, a user can initiate a PS payment from the payment page of a merchant Internet site.

In the particular embodiment of FIG. 3B, the user initiate a PS payment by selecting the PS service as a means of payment to pay his purchase, by clicking on a corresponding button displayed on the payment page of the merchant site.

If the internet user initiates the payment without being registered as a user of the PS service, he is first invited to subscribe to that service. He may then access directly the payment page of the merchant site within the private environment of his PS service, and not the home page of this PS service.

The user then access a PS interface (“Summary screen” in FIG. 3A) from which he can:
view the brief summary of his order,
select the transactional account with which he wishes to pay his purchase (in case the user uses two or more linked PS services)

Thus, the user may be able to check the balance of the transactional account(s) before paying his purchase, without having to separately connect to the Internet sites of his banks, and to select that transactional account which is the most appropriate to pay the purchase. This makes it possible for the user to better control his expenses.

Preferably, the PS interface displays only the transactional accounts linked to PS services that make it possible to perform the transaction. For example, if the user wishes to make a purchase abroad (i.e. from a merchant located outside the country where the user lives), preferably only the transactional accounts enabling payments abroad will be displayed. If none of the transactional accounts of the user allows the transaction, the payment will be interrupted and the user will not be allowed to select an account.

After selection of a transactional account by the user, if the transaction is not subject to an authorization request, the user carries out the last step of the payment procedure, which is described below.

On the other hand, if the transaction is subject to an authorization request, an intermediary screen (“Waiting screen”) in FIG. 3B is displayed, inviting the user to wait for the response to the authorization request.

The waiting screen may be displayed during a few seconds, even if the updating of the selected transactional account is terminated. This is because the waiting screen displays a targeted advertisement (“AD” in FIG. 3B).

If the response to the authorization request is positive, the user carries out the last step of the payment procedure, described below.

On the other hand, if the response to the authorization request is negative, a second intermediary screen (not shown in FIG. 3B) is displayed, which informs the user of the refusal of the payment authorization and which invites the user to select another transactional account.

Following acceptance of payment, the user carries out the last step of the payment procedure, which consists of accessing the page of confirmation of his order on the merchant site (within the navigation frame of his PS service).

The page confirms the transmission of the payment and of the billing and delivery address to the merchant.

As shown by the dashed lines in FIG. 3B, the usual validation page, payment page and validation page of the merchant site are replaced by the summary screen and the waiting screen of the PS system.

It can be seen that the present invention has, in examples, many advantages both for the consumers and for the merchants.

For the consumers, the invention may offers high security of transactions, since the user does not transmit confidential bank account information (such as bank card number) to the merchant site. Moreover, the payment is simple and user-friendly. Furthermore, the invention may give the user the possibility of checking the balance of one or more of his bank accounts (whatever the banks those accounts are held) before paying his purchase and therefore, of better controlling his expenses than with the conventional electronic means of payment (like plastic card).

For merchants, the invention may have the advantage of offering an easy and quick integration of the PS solution on the merchant Internet site. Besides, the invention may provide good follow-up and traceability of the transaction.

Procedure for a PS Payment on the Mobile Internet

In addition to payment on the fixed Internet, which has been described above, the invention may also provide a possibility of PS payment on the mobile internet, either from the “basket” page, or the “payment” page of any PS affiliated mobile merchant site. In both cases, the payment procedure is identical to the procedures described above for the fixed Internet. Only the visual presentation on the screen of the mobile terminal of the user may differ, depending e.g. on the architecture of the menus and/or of the size of the screen of the terminal.

Procedure for a PS Payment in a Physical Point of Sale

Moreover, in addition to payment via the fixed or mobile Internet, it may be possible to pay purchase made in a physical point of sale (a so-called convenience store purchase), via a mobile terminal and preferably using a contactless technology such as NFC (“Near Field Communication”), NFC being mentioned as a non-limiting example.

A user may initiate a convenience store purchase:
either by selecting “M-payment” in the general menu of his PS mobile service and then by following the instructions of the intermediary screen, by presenting his mobile terminal in front of the NFC payment terminal of the merchant;
or by directly presenting his NFC terminal in front of the NFC reader of the merchant.

In both cases, the terminal mobile operates in a reading mode and makes it possible to read the amount of the transaction previously registered by the merchant. Preferably, a light animation and/or a sound will confirm recognition of the mobile terminal of the user.

Thus, the user may be able to check the balance of the transactional account(s) before paying his purchase, without having to separately connect to the Internet sites of his banks, and to select that transactional account which is the most appropriate to pay the purchase. This makes it possible for the user to better control his expenses.

Preferably, the PS interface displays only the transactional accounts linked to PS services that make it possible to perform the transaction. For example, if the user wishes to make a purchase abroad (i.e. from a merchant located outside the country where the user lives), preferably only the transactional accounts enabling payments abroad will be displayed. If none of the transactional accounts of the user allows the transaction, the payment will be interrupted and the user will not be allowed to select an account.

After selection of a transactional account by the user, if the transaction is not subject to an authorization request, the user carries out the last step of the payment procedure, which is described below.

On the other hand, if the transaction is subject to an authorization request, an intermediary screen (“Waiting screen” like in FIGS. 3A and 3B) is displayed, inviting the user to wait for the response to the authorization request.

The waiting screen may be displayed during a few seconds, even if the updating of the selected transactional account is terminated. This is because the waiting screen displays a targeted advertisement (“AD” in FIG. 3B).

If the response to the authorization request is positive, the user carries out the last step of the payment procedure, described below.

On the other hand, if the response to the authorization request is negative, a second intermediary screen (not shown in FIG. 3B) is displayed, which informs the user of the refusal of the payment authorization and which invites the user to select another transactional account.

Following acceptance of payment, the user carries out the last step of the payment procedure, during which he is invited to again present his mobile terminal in front of the NFC reader of the merchant.

The payment receipt is then printed, which constitutes the proof for the merchant that the payment has been made.

The mobile terminals used for completing payments via the PS system in physical points of sale must have contactless capabilities and must be connected to the Internet for providing access to the PS service (via an application or a mobile site). The PS service will be a “in the cloud” payment service, working on any device running any operating system.

In order to accept PS convenience store payments, storekeepers (in physical point of sales) must use payment terminals able to communicate with a PS service, (i.e. with contactless capabilities and a PS merchant acceptance software). Ideally, these special PS payment terminals will handle indifferently:
bank card payment, whether contactless or with contact
NFC mobile payment via (digital) bank cards, coupons, gifts cards
NFC mobile payment via the PS system

The PS convenience store payment solution may offer many advantages both for consumers and storekeepers.

For consumers, the invention may provide a high level of security, because the means of payment does not leave the hands of the consumer. In addition, it is quick and easy to use. Moreover, the user has the possibility of checking his various transactional accounts before paying a purchase and can therefore better control his expenses.

For storekeepers, the invention may also provide speed and simplicity. Besides, the invention may provide easy follow-up and traceability of the transaction.

Procedure for a PS Cash Withdrawal

The PS service also allows cash withdrawal operations to be carried out in automatic teller machines (ATM) via a mobile terminal, through a contactless procedure, for example using the NFC technology.

The user may initiate a PS cash withdrawal in two different ways:
either by selecting “M-Withdrawal” in the general menu of his PS mobile service and, by following the instructions of an intermediary screen, by presenting his mobile terminal in front of the NFC reader of the ATM;
or by directly presenting his NFC terminal in front of the NFC reader of the ATM.

In both cases, the terminal mobile operates in a reading mode and makes it possible to read the amounts of cash withdrawal usually proposed by the ATM. Preferably, a light animation and/or a sound will confirm recognition of the mobile terminal of the user.

Next, the user selects the desired amount of money on the screen of his mobile terminal. The user then accesses a PS interface, from which he can:
view the amount of the cash withdrawal previously selected;
select the transactional account with which he wishes to withdraw money.

The internet user can thus check the balance of his various bank accounts before the cash withdrawal and therefore better control his expenses.

After selection of a transactional account by the user, if the transaction is not subject to an authorization request, the user carries out the last step of the payment procedure, which is described below.

On the other hand, if the transaction is subject to an authorization request, an intermediary screen (“Waiting screen” like in FIGS. 3A and 3B) is displayed, inviting the user to wait for the response to the authorization request.

The waiting screen may be displayed during a few seconds, even if the updating of the selected transactional account is terminated. This is because the waiting screen displays a targeted advertisement (“AD” in FIG. 3B).

If the response to the authorization request is positive, the user carries out the last step of the payment procedure, described below.

On the other hand, if the response to the authorization request is negative, a second intermediary screen (not shown in FIG. 3B) is displayed, which informs the user of the refusal of the payment authorization and which invites the user to select another transactional account.

Following acceptance of payment, the user carries out the last step of the cash withdrawal procedure, during which he's invited to again present his mobile terminal in front of the NFC reader of the ATM in order to obtain his cash as well as printed ticket confirming the transaction.

The mobile terminals used for completing cash withdrawals at ATM via the PS system must have contactless capabilities and must be connected to the Internet for providing access to the PS service (via an application or a mobile site). The PS service will be a “in the cloud” payment service, working with any device running on any operating system.

In order to accept PS cash withdrawal, an ATM must have contactless capabilities and be able to communicate with the PS service, by integrating a PS cash withdrawal software.

The PS cash withdrawal service constitutes a means of cash withdrawal that is more advantageous than the conventional cash withdrawal via bank card, because is in particular more secured, since it is not possible to steal the PS user information by pirating the ATM. Besides, the invention may offer the user the possibility of consulting his various bank accounts before withdrawing cash from the most appropriate account.

Acquisition

The collecting of the payment transactions i.e. all kinds of operations including in particular payment operations, cash withdrawal operations and money transfer operations, in view of their financial settlement, is not made as in bank card networks from the merchants, but directly from the PS services.

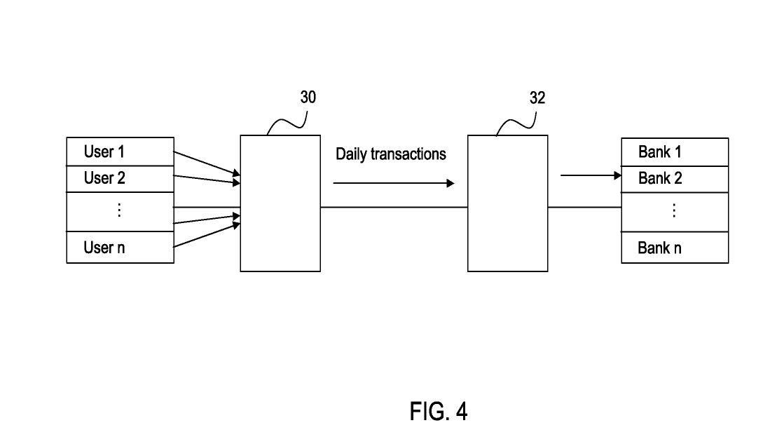

On a periodical basis, for example every day at a predefined time, the PS services transmit to their respective emitting banks, for instance via the File transfer Protocol (FTP), their respective transactions of the day, as shown in FIG. 4.

As shown in FIG. 4, at the above mentioned predefined time, the transaction data are firstly sent from all the PS service users who are clients of bank b, with 1≦b≦n, to a server 30 of the “PS user” application which is dedicated to the clients of bank b. Next, the transaction data collected by server 30 are transmitted to a server 32 of the “PS bank” application dedicated to the PS affiliated banks. Lastly, the data received by the server 32 are transmitted to bank b.

Once all the transactions of the day are collected, the emitting banks are able to settle the transactions i.e. they debit the account of the PS service users and transmit to the purchasing bank, for instance via FTP, the information relating to the transactions.

The purchasing banks are then also able to settle the transaction i.e. they credit the account of the merchants by the amount of the transactions, possibly reduced by the amount of the commission paid by the merchants, and register the transactions in their back-office.

Security

The present invention may provide a high level of security for users as well as banks and merchants.

The users of PS applications have to undergo authentication procedures, using any means found appropriate by the skilled person. For instance, specific personal authentication cards or biometrics can be used.

The opening of a PS user account is a secured procedure, as follows. Following the creation of a user account by a bank, the PS central platform 10 automatically generates identifiers which will allow the user to subscribe to a PS service or to aggregate a new PS service to a pre-existing PS service. The generation of identifiers is carried out totally independently from the bank of the user. Therefore, the bank does not have access to the identifiers. The identifiers are then transmitted to the user in an e-mail which is preferably encrypted and the user is authenticated by a code that is sent to the user mobile terminal and by a specific personal tracking procedure included in the e-mail.

The opening of a PS merchant account is also a secured procedure. Following the creation of a merchant account by a bank, the PS central platform 10 automatically generates identifiers which will allow the merchant to access his back-office, totally independently from the bank. Therefore, the bank does not have access to the identifiers. The identifiers are then transmitted to the merchant in an e-mail which is preferably encrypted and the merchant is authenticated by a code that is sent to the merchant mobile terminal and by a specific personal tracking procedure included in the e-mail. The identifiers can be modified by the merchant after the merchant accesses his back-office.

Optionally, the PS service may be parameterized in such a manner that the users are immediately advised by SMS and/or by e-mail of:
any transaction carried out from their PS service(s); and
any connection to their PS service(s) made from an IP (Internet Protocol) located in a geographical area very different from the area from which the previous connection was made (which is a priori suspicious).

Thus, in any case, the user can if necessary quickly block his PS service(s).

In a particular embodiment, in order to block a PS service, the user has to connect to that service, select his account via a particular menu (“MY ACCOUNTS”) and deactivate from a “dashboard” or from a given category of accounts the transactional account which is associated to the considered service to be blocked. The deactivation is performed for example by selecting, e.g. by clicking on, a link named “Block the service” which is located near the name of the account and by confirming that action.

Optionally, the transactional accounts, i.e. the accounts to be used during a payment, cash withdrawal or money transfer operation, can be distinguished more easily from the other accounts (not to be used for payment, cash withdrawal or money transfer) by a logo “PS” displayed near these transactional accounts.

After being deactivated, a transactional account cannot be used any more to perform payment, cash withdrawal or money transfer operations.

Optionally, in order to enhance security, the user can also be requested to modify his identifiers upon disconnection after deactivation of a service.

The reactivation of the transactional account of a PS service can be initiated by the bank emitting that service, from the user account. In such a case, the user receives in an e-mail which is preferably encrypted new identifiers which enable him to restore the payment (or withdrawal or money transfer) function of his PS service. For example, the user has to select e.g. by clicking on, a link named “Reactivate” located beside the name of the deactivated transactional account, to input the new identifiers received from his bank and to confirm the action.

Variants

The invention has been described with reference to preferred embodiments. However, many variations are possible within the scope of the invention. In particular, the national interbank online payment system may optionally be a national private (or three-party) online payment system, also known as proprietary payment system. In such a case, the manager of the payment system (which may be, for instance, a financial institution or a retailer) ensures directly the management of the merchants and consumers accounts and define itself the range of payments products that will be distributed to the consumers from the system. According to another aspect, the invention also provides an international online payment system comprising a network of at least two national private online payment systems according to the above.

From a technical point of view, a national private online payment system is very similar to a national interbank online payment system. The main difference between the two systems is the suppression of the bank software module (i.e. building block) and the PS bank application in the national private online payment systems, which means that, in addition to performing marketing and technical functions as described above, the manager of such a national privative online payment system will also ensure the management of consumers and merchants accounts and the definition of the range of payment products proposed through the system (instead of the banks).

I claim:

1. An online payment system connecting consumers, consumer banks, merchants and/or merchant banks via a fixed and/or a mobile telecommunication network, wherein said payment system comprises:
an automated information system adapted to communicate with a plurality of national banks affiliated to said payment system,
a plurality of fixed payment terminals, and
a plurality of mobile payment terminals,
said automated information system comprising an aggregation module that manages a plurality of personal user accounts, said automated information system giving said consumers access to a plurality of services including payment, cash withdrawal and/or money transfer.

2. A payment system according to claim 1, wherein said plurality of personal accounts includes at least one transactional account, to be used during a payment, cash withdrawal or money transfer operation.

3. A payment system according to claim 1, wherein said plurality of personal accounts includes at least one account not to be used during a payment, cash withdrawal or money transfer operation.

4. A payment system according to claim 2, further comprising:
a comparison module that compares a balance of said at least one transactional account with an amount of a payment, cash withdrawal or money transfer requested by a user; and
a security module that authorizes or refuses said requested payment, cash withdrawal or money transfer, depending on the result of the comparison.

5. A payment system according to claim 1, further comprising an updater of the contents of at least one account of said plurality of personal accounts upon connection of a user to said payment system.

6. A payment system according to claim 2, wherein said plurality of personal accounts includes at least two transactional accounts owned by a user in two different banks of said plurality of banks and wherein said payment system further comprises an interface that provides a user with a current balance of said at least two transactional accounts before performing a payment, cash withdrawal or money transfer operation.

7. A payment system according to claim 6, further comprising a selector of one of said at least two transactional accounts by said user for performing said payment, cash withdrawal or money transfer operation.

8. A payment system according to claim 7, further comprising a safety module that requests from the user a modification of the selection of said transactional account selected for performing said payment, cash withdrawal or money transfer operation, in case a balance of said selected account is insufficient in view of an amount of said payment, cash withdrawal or money transfer operation.

9. A payment system according to claim 1, wherein each mobile payment terminal of said plurality of mobile payment terminals is a contactless communication terminal.

10. A payment system according to claim 9, each mobile payment terminal of said plurality of mobile payment terminals supports NFC (Near Field Communication) technology.

11. A payment system according to claim 1, wherein each mobile payment terminal of said plurality of mobile payment terminals comprises a fingerprint reader.

12. A payment system according to claim 1, further comprising a sending unit that periodically electronically sends data relating to payment, cash withdrawal and money transfer operations performed by users to those respective banks of said plurality of banks that are concerned by said operations.

13. A payment system according to claim 1, wherein the system is an interbank or four-party online payment system connecting consumers, consumer banks, merchants and merchant banks.

14. A payment system according to claim 13, wherein the system is a national interbank online payment system.

15. A payment system according to claim 1, wherein the system is a private (or proprietary) or three-party online payment system.

16. A payment system according to claim 15, wherein the system is a national online payment system or an international online payment system comprising a network of at least two national online payment systems.

17. A payment system according to claim 1, wherein the system is an international online payment system comprising a network of at least two national interbank online payment systems.

18. An internet payment system, wherein the system comprises:
an aggregation module, the aggregation module comprising a data storage medium having recorded thereon a computer program including instructions to aggregate a plurality of personal user accounts, including at least two bank accounts of different banks,
an interfacing module, the interfacing module offering to users an access to a personalized graphical user interface and comprising a data storage medium having recorded thereon a computer program including instructions to display on a single view data related to the plurality of personal user accounts, including balance data of the two bank accounts, and
a payment module, the payment module comprising a data storage medium having recorded thereon a computer program including instructions to perform online payment through user-interaction with the personal graphical user interface.

19. A method for performing an online or an electronic payment, wherein the method comprises:
importing information related to a product in a graphical user interface of a fixed or a mobile payment terminal,
displaying to the user, on a display of the payment terminal, balances of at least two bank accounts of different banks,
selection by the user of one of the two bank accounts, based on the displayed balances, thereby launching purchase of the product by payment from the selected bank account.
